(19) United States
(12) Patent Application Publication
(10) Pub. No.: US 2006/0028634 A1
(43) Pub. Date: Feb. 9, 2006

(54) Multiple exposures of photosensitve material

(76) Inventors: Andrew Jonathan Tuberfield, Oxfordshire (GB); Robert Gordon Denning, Oxford (GB)

Correspondence Address: NIXON & VANDERHYE, PC, 901 NORTH GLEBE ROAD, 11TH FLOOR, ARLINGTON, VA, 22203, US

(21) Appl. No.: 10/532,236

(22) PCT Filed: Oct. 16, 2003
(86) PCT No.: PCT/GB03/04502

§ 371 Date: Apr. 22, 2005

(30) Foreign Application Priority Data
Oct. 22, 2002 (GB) 0224529.8

(51) Int. Cl. G03B 27/32

(52) U.S. Cl. 355/77

(57) ABSTRACT

A method of accurately registering successive exposures of photosensitive material by forming between the exposures an image of the latent exposure pattern caused by initial exposures. In a photosensitive material comprising a photo acid generator and an acid-catalyzed cross-linkable resin precursor, the image may be obtained by including in the photosensitive material a pH sensitive dye which responds to the liberation of acid in the first exposure to reveal the position of the first exposure. The image may be a three-dimensional image which is then used to control the position and intensity of further exposures. The technique is particularly applicable to the production of photonic crystals with local structural modifications such as are required to define waveguides or resonators.

The present invention relates to improvements in performing multiple exposures of photosensitive materials, and in particular to an improved way of registering or aligning successive exposures.

The fabrication of structures involving defining the structure in a photosensitive material by means of appropriate illumination of the photosensitive material and subsequent development of the photosensitive material is used in many fields. Often, because of the complexity of the structure, it is not possible or not convenient to define the structure by means of a single exposure. Instead multiple exposures of the photosensitive material are used. In order that the result of multiple exposures is as desired, it is necessary to be sure that each of the exposures is accurately positioned, or registered, with previous exposures. If exposures are being performed on the same equipment, soon after each other, without movement of the sample, this may be relatively straightforward. Sometimes, however, it is necessary for different exposures to be made by different equipment, or for the sample to be moved between exposures, or the position of the initial exposures may not be precisely known.

An example of a technique using optical exposure to define a complex structure is the method of forming so-called “photonic crystals” described in U.S. Pat. No. 6,358,653 B1, which is herein incorporated by reference in its entirety. A photonic crystal is an optical structure which has a refractive index variation which repeats periodically in two or three dimensions. In a photonic crystal the period of repetition is set to be similar to the wavelength of light with which the photonic crystal is to be used. The effect of the periodically varying refractive index is to establish “forbidden bands” by preventing propagation of the light in one or more directions through the photonic crystal. A variety of ways of forming a photonic crystal have been proposed. The abovementioned U.S. Pat. No. 6,358,653 discloses a method involving the exposure of a photosensitive material to an interference pattern formed by beams of electromagnetic radiation converging in the sample. The relative intensity and polarisation of the beams is chosen so as to produce a particular pattern of exposure which, after development of the photosensitive material to remove or modify it in certain regions according to the extent of their exposure, forms the desired connected network having three-dimensional periodic variation in its refractive index. An advantage of this method is that there is considerable flexibility in which structures can be formed and also the whole crystal can be made simultaneously by a short (e.g. 5 ns) pulse of UV light. While this technique enables the production of high quality three-dimensional photonic crystals more straightforwardly than other techniques, the position of the interference pattern in the photosensitive material is highly dependent upon the precise mutual phase relationship of the interfering beams. Thus a small change in phase, for instance induced by a very small change in one of the path lengths, causes the interference pattern to shift significantly. This means that it is difficult to be sure of the position of the interference pattern in the photosensitive material until after development unless precautions are talken to ensure adequate (sub-wavelength) dimensional control or stability of the apparatus which adds significantly to its complexity and cost.

Other methods of forming photonic crystal, particularly in two-dimensions, are known, for instance based on standard methods of electron-beam lithography, assembly of small glass or polystyrene spheres or point-by-point conversion of photosensitive material at the focus of a microscope objective (see, for example, S. Kawata et al., Nature, 412, 697 (2002) and B. H. Cumpston et al., Nature, 398, 51 (1999)).

Point-by point methods of defining photonic crystals, however, are intrinsically slow because each point in the lattice must be addressed sequentially. For example, it may take three hours to define a three-dimensional structure in a 10×10×10 micrometre cube of photosensitive material. The methods of formation of photonic crystals using self-assembling spheres, on the other hand, although simple and relatively quick, offer little structural flexibility and are susceptible to the uncontrolled inclusion of defects at arbitrary positions. Electron-beam lithography methods are also complex and time-consuming.

Applications of photonic crystals in practical optical device elements, however, require the formation of localised features in the photonic crystal in which the periodic variation in refractive index is disturbed to produce, for example, waveguides (linear defects), micro-cavities (point defects) etc. To function properly, such features must be precisely located relative to the repeating structural elements that form the photonic crystal lattice. It can be difficult, however, to achieve such precise location.

Although the introduction of precisely localised structural features within a three-dimensional lattice is conceptually straightforward in layer-by-layer and point-by-point fabrication methods (but laborious in practice), no procedure has yet been devised that can be applied to self-assembled structures. Braun et al. (Advanced Materials, 14(4), 271 (2002)) have described a hybrid technique for defining a waveguide structure within a photonic crystal lattice. The lattice is first formed by sintering self-assembled silica spheres. The voids are then filled with a photosensitive material, and waveguide structures are written by two- or three-photon polymerisation of this material. After dissolution and removal of unpolymerised material, the polymerized waveguide can be located by imaging, in a confocal microscope (CFM), the distribution of a dye solution subsequently introduced into the voids. This method creates features that are large compared to the diameter of the silica spheres and are not in register with the underlying lattice—they are written at an arbitrary position and their location is determined only after they have been formed. Thus the method is subject (a) to the inclusion of the random defects found in all self-assembled structures, (b) to the limitations on crystal structure imposed by a spherical structural basis, and (c) to a loss of spatial resolution caused by wavefront aberrations due to refractive index inhomogeneities in the silica-resist composite.

It would be useful, therefore, to have a method of aligning plural exposures which does not rely on the inclusion of special registration marks and which is accurate enough to allow the precise positioning of subsequent exposures in relation to an initial exposure.

Accordingly the present invention provides a technique in which a latent exposure pattern created by one exposure is imaged to determine its position before development, and the position of subsequent exposures is controlled based on the determined position of the initial exposure. In more detail, a first aspect of the invention provides a method of controlling the relative position of a plurality of optical exposures of a photosensitive material, comprising:

making an exposure of the photosensitive material by illuminating it with a first pattern of light to create therein a corresponding latent exposure pattern;

imaging the exposed photosensitive material to reveal and determine the position of the latent exposure pattern; and

controlling the position of at least one further exposure of the photosensitive material based on the determined position of the latent exposure pattern.

The imaging may take place at a different wavelength from the first-mentioned and further exposures, which indeed may be at different wavelengths from each other. Alternatively the imaging and writing wavelengths may be the same, for example with a low intensity excitation used for imaging, and a high intensity (e.g. high enough for multiple-photon excitation) used for writing. The photosensitive material may comprise an indicative material which is sensitive to the local extent of the exposure and which is revealed by the imaging step. For example, the indicative material may be sensitive to chemical changes induced in the photosensitive material by the exposure. An example of this is a pH sensitive fluorescent dye which responds to the release of acid from a photo-acid generator (PAG) in an acid-catalysed photo-resist being used as the photosensitive material. Typical examples of such dyes are Rhodamine B, CI-NERF (from Molecular Probes Corp., Eugene, Oreg.) or the dyes listed in U.S. Pat. No. 6,376,149, herein incorporated by reference. Depending on the imaging mechanism, this may involve the use of different excitation and detection wavelengths.

The first-mentioned exposure may be an exposure to a pattern of light which repeats regularly in two or three-dimensions, for instance to define regions in the photosensitive material which will form a photonic crystal lattice. Thus it may be an interference pattern formed by the intersection of plural light beams as described in U.S. Pat. No. 6,358,653. The further exposure may be an exposure which defines modifications to the photonic crystal lattice, such as modifications which will form a structure operating as a waveguide (a linear structure) or a resonator (a point structure). This may be achieved by means of multiple-photon (e.g. two or three photon) absorption in the photosensitive material achieved by using a writing light beam formed, for example, by a confocal microscope. This focusses the light beam at a desired position (in three-dimensions) in the photosensitive material such that at the focus the intensity is high enough to raise the probability of multiple photon absorption and trigger the desired chemical change in the photosensitive material.

The imaging may be achieved by a confocal microscope or by a scanning focussed laser beam, or by some other form of illumination depending upon the physical mechanism for imaging. The image preferably consists of a three-dimensional map of the latent exposure pattern in the photosensitive material, which can be used to control the position of the further exposures. The image and further exposure steps may be repeated until the desired latent exposure pattern is obtained. The optical apparatus used to control the position of the further exposures may be the same as, or share components with, the optical apparatus used for imaging.

Where the photosensitive material comprises a photo-acid generator, it is possible also to include in the photosensitive material a photo-base generator, typically with a sensitiser therefore, which is activated in the further exposures (for instance by using a photo-base generator which is responsive to a different wavelength from the first exposure and using that different wavelength for the further exposures), the base released in the further exposures neutralising the acid released by the initial exposure, thus allowing the further exposures to subtract from the initial pattern, rather than add to it. Examples of base generators are described in M. Tsunooka et al. J. Polymer Science, A 39, 1329 (2001) herein incorporated by reference.

The photosensitive material may be one possessing an average number of cosslinkable groups per molecule of at least 3 with an equivalent weight per cosslinkable group of at most 1000, such as a cross-linkable epoxy resin precursor. Photosensitive materials including acid generators such as those described in EP-A-1214614, herein incorporated by reference in its entirety, may be used.

It will be appreciated that after the desired number of exposures to create the final desired latent exposure pattern, the photosensitive material is developed, for instance chemically and/or thermally, to create the desired structure. Thus regions of the photosensitive material are selectively removed on the basis of their exposure level. This may be a “positive” process in which the regions removed correspond to regions which have received a high exposure, or a “negative” process in which the regions removed correspond to regions which have received a low exposure.

The structure formed in this way may be used directly as an optical element if it has the desired optical characteristics (such as transparency and a suitable refractive index), or it may be used as a template for forming such an optical element. This may be achieved by filling the voids in the structure with a material having the desired optical characteristics, and then removing (e.g. chemically and/or thermally) the template structure.

The invention will be further described by way of example with reference to the accompanying drawings in which:

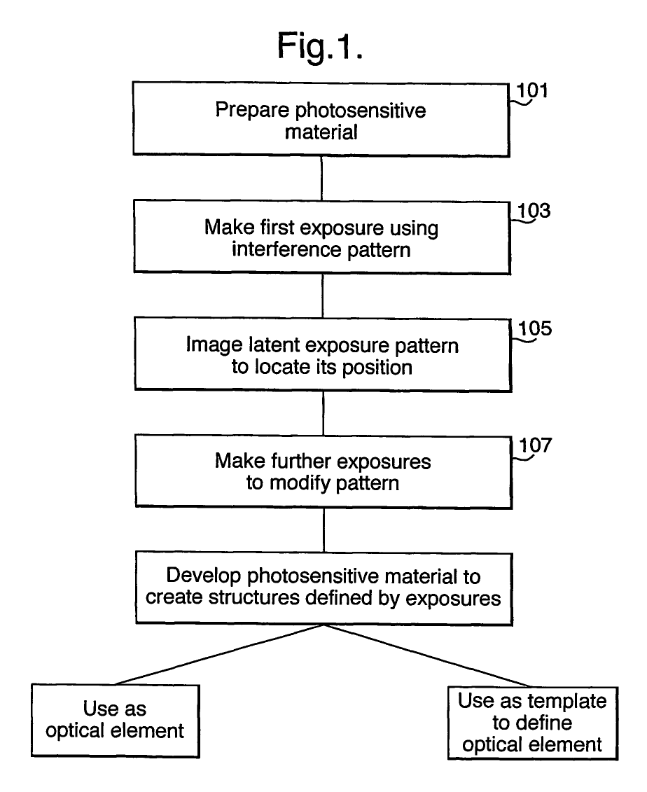

FIG. 1 is a flow diagram describing an example of the technique;

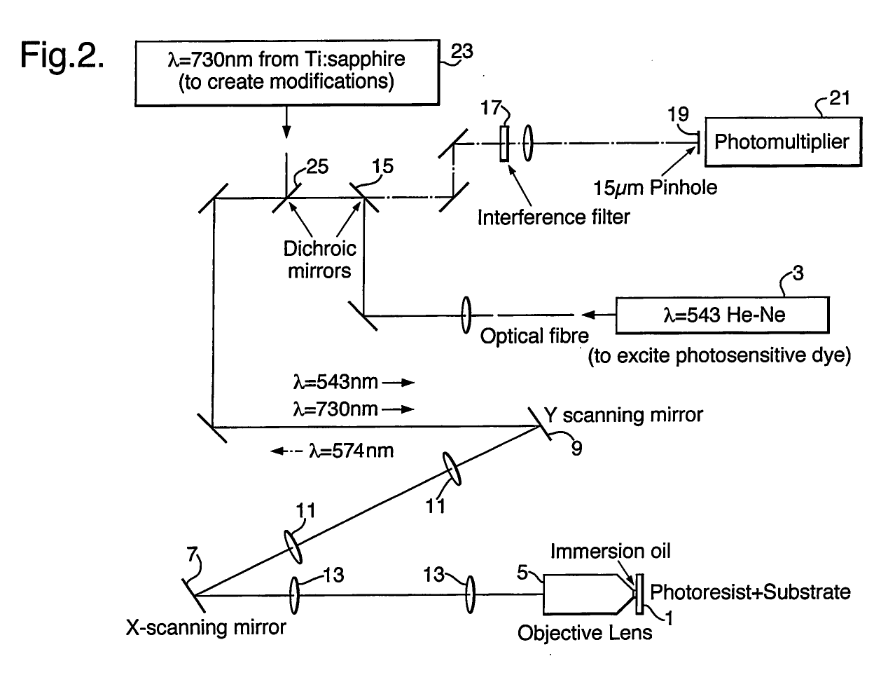

FIGS. 2 is a schematic diagram of the apparatus for exposing the photosensitive material in one embodiment of the invention;

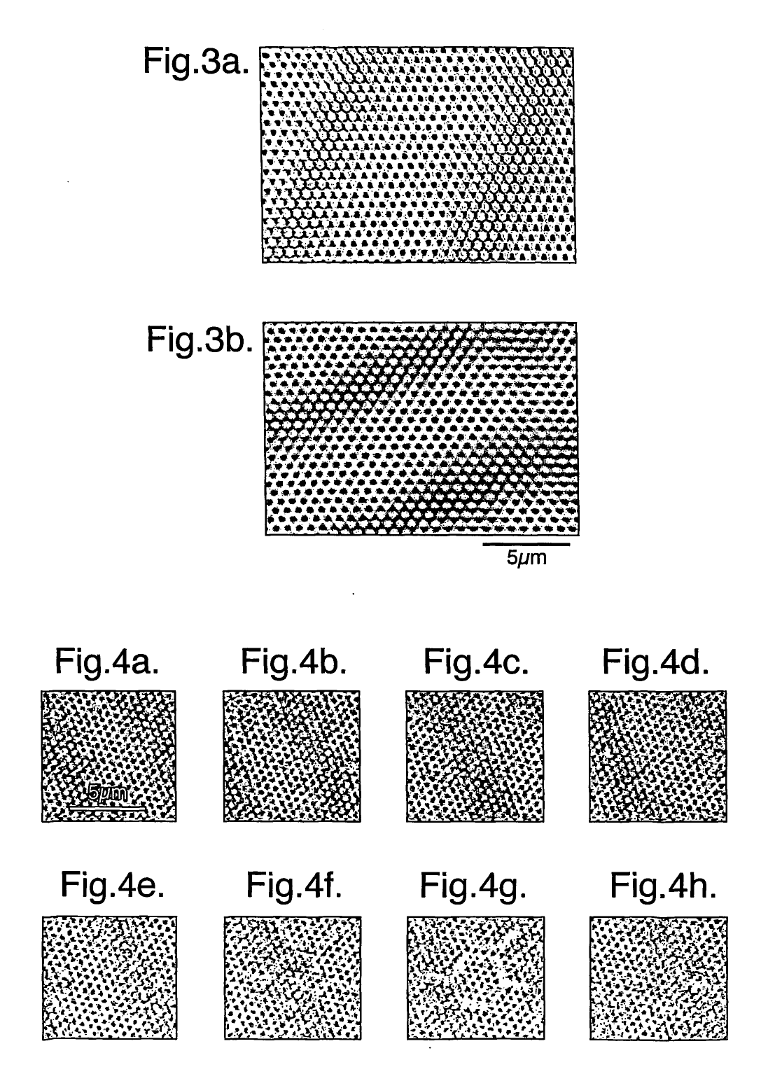

FIG. 3 show images of a structure and a latent exposure pattern formed in one embodiment of the invention; and

FIG. 4 is an image of a further structure formed in an embodiment of the invention.

FIG. 1 illustrates the overall process of one embodiment of the invention. In step 101 a photosensitive material is prepared. Suitable photosensitive materials are disclosed in U.S. Pat. No. 6,358,653 and also EP-A-1214614 incorporated herein by reference in their entirety. An example of such a photosensitive material is an acid-catalysed cross-linkable epoxy resin precursor which is mixed with a photo acid generator, optionally a two-photon PAG sensitiser, and a pH sensitive dye. The photosensitive material may conveniently be prepared in the form of a film.

After preparation the photosensitive material is then subjected to a first exposure. As indicated in step 103 of FIG. 1, in this embodiment this is an exposure using a four-beam interference pattern which is arranged to expose sufficiently certain regions of the photosensitive material such that upon development they will form a connected photonic crystal lattice. This technique is described fully in U.S. Pat. No. 6,358,653. As mentioned above, though, even with careful control of the beams forming the interference pattern, it is very difficult to be completely sure of the position of the interference pattern in the photosensitive material. Therefore, in accordance with the invention, the latent exposure pattern created by the first exposure is imaged in step 105. This is achieved in this embodiment by illuminating the photosensitive material with light of a suitable wavelength to image the pH-sensitive dye included in the photosensitive material. This may be achieved by using a confocal microscope as explained below with reference to FIG. 2, or a scanning focussed laser beam using the imaging technique of U.S. Pat. No. 6,376,149. This information is then used to control the position at which a pulse or sequence of pulses of light of a suitable wavelength is focussed in the further exposures of step 107. These further exposures may use the same microscope as the imaging step, and they are controlled to induce via two or three-photon excitation of the PAG, the liberation of additional acid at the specific location in the photosensitive material where a modification to the pattern created by the first exposure is required. By using two or three photon excitation it is possible to “address” different depths in the photosensitive material by arranging for the writing beam to be focused at the desired depth. This means that while at the focus the intensity is high enough for there to be a high probability of two or three photons being present, at other depths where the beam is not focussed, the intensity is lower and thus there is a low probability of two or three photon excitation occurring.

FIG. 2 is a schematic diagram of the apparatus for performing the imaging and further exposure steps in this embodiment. In this apparatus fluorescence (at 574 nm) from the pH-sensitive dye included in the photosensitive material 1 is excited by light from a 543 nm HeNe laser 3 which is focussed within the layer of photosensitive material 1 by means of an objective lens 5; the position of the focus is scanned in three dimensions by means of x- and y-scanning mirrors 7, 9 (which are imaged onto each other and onto the pupil of the objective 5 by pairs of lenses 11, 13 forming 4f imaging systems) and by a motorised adjustment of the separation of the objective 5 and photosensitive material 1. Emission from the indicator dye is collected by the same objective lens 5, follows the reverse optical path past the scanning mirrors 7, 9, is separated by a dichroic mirror 15 and filtered by a bandpass interference filter 17, and a confocal image of the focal point of the objective 5 is formed on a 15 μm pinhole 19. Dye emission from the focus of the objective 5 passes through the pinhole 19 and is detected by a photo multiplier 21. By recording the intensity of indicator dye emission as the position of the focal point is scanned a three-dimensional image of the distribution of photo-acid is obtained.

In order to produce the further exposure of the photosensitive material 1, light from a 730 nm mode locked Ti:sapphire laser 23 is introduced into the same optical path as the light from the HeNe laser 3 by means of a dichroic mirror 25. Additional photo-acid is generated by two-photon excitation which occurs predominantly at the focus of the objective 5. The generation of additional photo-acid is controlled, with reference to the image of pre-existing photo-acid, by controlling the position of the focus using the same scanning mechanisms that are used to image the pre-existing photo-acid and by controlling the magnitude of the exposure at each point by adjusting the scan rate or by means of a shutter (not shown).

After thermal processing and development, the resulting structure will contain localised features determined by the addition of the two exposures. Since the acid concentration can be monitored (through the intensity of the dye fluorescence) at any point within the sample after every such exposure, any number of additional point exposures (of variable intensity) may be used to control precisely the local acid concentration, and so tailor the shape and size of the resulting structural element, or set of elements. Imaging may be repeated after each further exposure. When the acid density map, as determined by imaging, contains the required local acid distribution, the sample is processed by, for example, a “post-baking” heat treatment, and developed in a solvent to realize the required final structure. Thus not only the positional information in the image, but also the intensity information can be used to control the further exposures.

An important aspect is that the concentrations of photo-chemically converted PAG molecules and protonated dye molecules, following one or more exposures, are too small to change the local refractive index significantly. Providing that the catalytic role of the acid is thus “latent”, no major changes occur in the bulk chemical composition and density during the exposures. Prior to the thermal initiation of acid-catalysed processes (usually called chemical amplification), the sample remains effectively optically homogeneous, and the wavefront quality required for the accurate definition of the structure is not degraded by diffraction. The advantages of this invention, compared to the point-by-point definition of a three-dimensional pattern by serial two-photon writing, are most significant when the photonic crystal pattern is created by a single short initial exposure, as in the holographic technique of U.S. Pat. No. 6,358,653. Only the regions requiring modification then need to be addressed, and the volume of material that must be converted by two-photon writing is small, and so can be achieved quickly.

In the procedure described above, the effect of additional exposures is additive. So for example, in the case of a negative-working resist based on the formation of insoluble polymer in regions of high intensity, the initial exposure to a 3-dimensional interference pattern, following development, creates a replica of this pattern in polymerised epoxy resin.(M. Campbell et al. Nature 404, 53 (2000) herein incorporated by reference) Subsequent local exposures that liberate additional acid will lead to additional local polymer formation; for example increasing the size of particular elements of the polymer photonic crystal structure, or linking them together. In the case of positive-working resists, additional exposures will lead to the production of soluble material and its removal from the final structure.

However, in some applications, it may be advantageous for subsequent exposures to be subtractive, i.e. they should lead to the removal of polymer following the development stage or, in the case of positive-working resists, the addition of polymer. This may be achieved if a different wavelength is used to selectively excite a photo-base-generator, rather than the photo-acid generator, in the region where subtraction is required. A number of photo-base generating compounds are known in the art (M. Tsunooka et al. J. Polymer Science, A 39, 1329 (2001)). Some of these have high quantum efficiencies for base generation, and can be designed so that the absorbing chromophore is decoupled from the reactive centre, thus allowing its absorption to be optimized in a specific spectral region. (D. C. Neckers et al. Chemistry of Materials 11, 170 (1999)). Typical photo-base generators are O-acyloximes, ammonium tetra-organyl borate salts, and quaternary ammonium dithiocarbamate salts.

It should be noted that the method can be applied to materials whose refractive index is too small to give photonic crystals with a full photonic bandgap. Such structures formed in photoresist can be used as mentioned above as templates for the growth of semiconductor or other materials within the inter-connected voids, so that following the removal of the template, a photonic crystal exists as a framework of semiconductor or other high index material. Methods for achieving this are described in U.S. Pat. No. 6,358,653, and by M. Campbell, et al Nature 404, 53 (2000), and in a number of other publications (e.g. Y. Xia et al. Advanced Materials, 12, 693 (2000) and references therein) all herein incorporated by reference.

### EXAMPLE

For a better understanding of the present invention, a specific example will now be described.

A suitable procedure for the first exposure that defines the underlying photonic crystal structure is that described in PCT International patent application WO 01/22133 A1. The photoresist material is first dissolved in a suitable solvent and spun onto a glass disk. A solution of EPON-SU-8, typically 55% by weight in anhydrous cyclopentanone is filtered to exclude particles larger than 0.1 μm. Approximately 1 wt. % of tri-aryl sulfonium hexafluoroantimonate (the PAG) is also dissolved in this solution, together with low concentrations of perylene (0.007 M) (a two-photon PAG sensitiser) and rhodamine-B base (1×10⁻⁴M) (the pH sensitive dye). Approximately 1 ml of the solution is placed on a 22 mm diameter microscope coverslip (thickness 0.17 mm) in order to prepare a film with a thickness of several tens of μm and spun for 5 s with a ramp-up acceleration of 300 rpm/s, a 30 s hold and 5 s 300 rpm/s ramp-down time. The film is then heated gently to remove the solvent, typically at 50° C. for 5 minutes and 15 minutes at 90-100° C. The interval between film preparation and exposure should be kept as short as possible.

The film is then exposed to an interference pattern at the intersection of four beams from a frequency-tripled, injection seeded Q-switched Nd-YAG laser (wavelength 355 nm). The propagation directions, polarisation parameters and relative intensities of the four beams, required to generate a particular face-centred cubic photonic crystal lattice (with lattice parameter a), are listed in Table 1, (a=922 nm in air, and 566 nm in SU-8). The films were exposed to a single 7 ns pulse, the total dose being varied to control the required polymer/air ratio in the developed structure. The silica substrate was index-matched to a supporting Perspex rod using mineral oil, in order to minimize back-reflections into the sample.

TABLE 1

| Laser Wave-vector | Polarisation Vector | Relative Intensity |
|---|---|---|
| $\frac{π}{a} [ \overline{3} \overline{3} \overline{3} ]$ | Circular RH or LH | 9 |
| $\frac{π}{a} [ \overline{5} \overline{1} \overline{1} ]$ | Linear [0\overline{1}1] | 2 |
| $\frac{π}{a} [ \overline{1} \overline{5} \overline{1} ]$ | Linear [10\overline{1}] | 2 |
| $\frac{π}{a} [ \overline{1} \overline{1} \overline{5} ]$ | Linear [\overline{1}10] | 2 |

Following this exposure the sample was transferred to purpose-built confocal microscope. Images of the concentration of the protonated forms of Rhodamine-B or Coumarin 6 which absorb near 550 nm and emit near 570 nm, were obtained by irradiation at 543 nm using a green helium-neon laser. The emission was detected through a narrowband interference filter centred at 570 nm. The pattern of acid liberated by the initial holographic exposure before post-baking and development is clearly visible in FIG. 3b, and is effectively identical to the structure shown in FIG. 3a, which is a scanning electron micrograph of the surface of a second sample, exposed to the same holographic pattern, after post-baking and development. Light and dark banding, which occurs in both images because the image plane is slightly tilted with respect to the (111) plane of the structure, demonstrates the satisfactory resolution of the confocal optical micrograph normal to the image plane. Using the same apparatus modifications were defined within this structure by scanning the focussed output of a femtosecond infrared (710 nm) optical parametric amplifier over a sample which had first been exposed to the holographic pattern. Two-photon absorption (TPA) at this wavelength is only significant in the focal volume where the laser intensity is high, and generates additional photoacid at the focal point. To create precisely located structural defects the focus is vector-scanned in three dimensions through the lattice.

FIG. 4 demonstrates the control that can be achieved with this technique. Confocal images of the photoacid density reveal a latent image of a test structure written within and aligned to a 3D photonic crystal. The vertical separation between the eight image frames is 0.5μm. The bright dots in panels a-d show the location of the additional photo-acid needed to define four vertical ‘waveguides’ that are connected with the ends of the “Mach-Zender interferometer’ seen in panels f,g, either directly or by means of a “directional coupler”. The device structure occurs in only two frames, indicating that the structure has been defined with submicron precision.

Thus in this embodiment the imaging of latent photo-acid is used to align precisely two or more separate exposures of the photo-resist in such a way that the structure generated during subsequent development stages corresponds to an accurate, in register, superposition of the patterns created by the individual exposures. It is therefore unnecessary to form the structure, by post-baking and development, in order to determine its position. Instead the location of the latent structure due to the initial exposure is measured prior to development, so that modification can also be made prior to development. This is particularly advantageous where the precise position of the initial exposure is not known, for instance in the case of the initial exposure being an interference pattern generated by a short pulse exposure where it is difficult and complex to control actively the phases of the interfering beams. However, the technique of the invention is clearly applicable to other exposure techniques.

With the invention it is possible through the accuracy of the registration of the successive exposures to introduce into a photonic crystal lattice well-defined local structural variations, at a desired depth, to form structures such as waveguides and resonators with a high degree of optical confinement.

What is claimed is:

1. A method of controlling the relative position of a plurality of optical exposures of a photosensitive material, comprising:
making an exposure of the photosensitive material by illuminating it with a pattern of light to create therein a corresponding latent exposure pattern;
imaging the exposed photosensitive material to reveal and determine the position of the latent exposure pattern; and
controlling the position of at least one further exposure of the photosensitive material based on the determined position of the latent exposure pattern.

2. A method according to claim 1 wherein the exposed photosensitive material is imaged at a different wavelength from said first-mentioned or further exposures.

3. A method according to claim 1 wherein the photosensitive material comprises an indicative material sensitive to the local extent of the exposure and which in said imaging step reveals exposed areas of the photosensitive material.

4. A method according to claim 3 wherein said indicative material is sensitive to exposure-induced chemical changes in the photosensitive material.

5. A method according to claim 3 wherein said indicative material comprises a fluorescent or luminescent substance.

6. A method according claim 1 wherein said pattern of light is a pattern which regularly repeats in two or three dimensions.

7. A method according to claim 6 wherein said pattern of light is such as to define in the photosensitive material regions of the photosensitive material for forming a photonic crystal lattice.

8. A method according to claim 6 wherein said pattern of light is an interference pattern formed by the intersection of plural light beams in the photosensitive material.

9. A method according to claim 7 wherein the further exposure is such as to define a modification to the photonic crystal lattice.

10. A method according to claim 9 wherein said modification is a discontinuity for defining a structure operable as waveguide or resonator.

11. A method according to claim 1 wherein the at least one further exposure is made by multiple-photon absorption in the photosensitive material.

12. A method according to claim 1 wherein the further exposure is by a writing light beam illuminating a selectable position in the photosensitive material defined with respect to the imaged latent exposure pattern.

13. A method according to claim 12 wherein the writing light beam is formed by a confocal microscope.

14. A method according to claim 1 wherein the imaging is by a confocal microscope or scanning focussed laser beam.

15. A method according to claim 1 wherein the step of imaging forms a three dimensional image of the latent exposure pattern in the photosensitive material.

16. A method according to claim 1 wherein the photosensitive material comprises a photo-acid generator and each exposure causes the dissociation of the photo-acid generator, to form acid that acts as a latent catalyst for subsequent chemical development processes.

17. A method according to claim 16 in which the local acid concentration is determined in the imaging step by changes in the optical absorption or emission characteristics of an acid-sensitive dye included in the photosensitive material.

18. A method according to claim 16 in which the wavelength of said at least one further exposure is chosen so as to cause the dissociation of a photobase generator included in the photosensitive material that locally neutralizes the photoacid generated in earlier exposures.

19. A method according to claim 1 wherein the photosensitive material is a cross-linkable epoxy resin precursor.

20. A method according to claim 1 comprising alternately repeating said imaging and further exposure steps to build-up a desired latent exposure pattern.

21. A method of forming a structure in a photosensitive material by performing a plurality of exposures of the material controlled according to the method of claim 1 and developing the photosensitive material after said further exposure to remove regions of photosensitive material selectively on the basis of their exposure level.

22. A method according to claim 21 wherein the developing step comprises at least one of chemical and thermal treatment.

23. A method of forming an optical element by using a structure formed in accordance with the method of claim 21 as a template to define the optical element in a material of selected optical properties.

24. A method of forming an optical element by forming a structure in accordance with the method of claim 21 in a material having selected optical properties.
